(19) United States
(12) Patent Application Publication
(10) Pub. No.: US 2026/0326271 A1
(43) Pub. Date: Oct. 22, 2026

(54) TOOL SYSTEM COMPRISING A FIRST TOOL BIT AND A SECOND TOOL BIT

(71) Applicant: DAYSAVER AG, Zürich (CH)

(72) Inventor: Daniel LANDOLT, Birmensdorf (CH)

(73) Assignee: DAYSAVER AG, Zürich (CH)

(21) Appl. No.: 19/122,082

(22) PCT Filed: Oct. 12, 2023
(86) PCT No.: PCT/EP2023/078436

§ 371 Date: Apr. 17, 2025

(30) Foreign Application Priority Data
Oct. 25, 2022 (DE) 10 2022 128 158.2

(51) Int. Cl. B25B 23/00

(52) U.S. Cl. CPC B25B 23/0007

(57) ABSTRACT

A tool system including a first tool bit and a second tool bit, where both tool bits each have a first end with a shaft section for transmitting a drive force to the tool bit, and a second end having an output for force-transmitting insertion of the tool bit into a screw-head drive profile. Also, the front face of the shaft section of each tool bit being designed as an front-face coupling region for the coupling of the tool bit with a second tool bit of the tool system by first and second coupling means respectively incorporated in the front face, the first coupling means of both tool bits is configured for the relative rotational alignment of both tool bits with respect to the central longitudinal axis of at least one tool bit and wherein the second coupling means is configured for transferring a tensile force oriented parallel to this central longitudinal axis onto the respective other tool bit, the shaft sections of both tool bits have mutually congruent outer contours, and in a coupling position of both tool bits, in which both first coupling means of both tool bits are in direct mutual engagement with each other, form a common receiving section for introducing the tool system into a chuck of a drive tool.

The invention relates to a tool system comprising a first tool bit and a second tool bit, wherein both tool bits each have a first end with a shank portion for transmitting a drive force to the tool bit and a second end with an output for force-transmitting insertion of the tool bit into a screw head drive profile.

Tool bits are known in large numbers from the prior art and are used to transmit a torque generated by a drive to a screw. In most cases, these are interchangeable screwdriver blades without an operating handle that can be inserted into the corresponding chuck of an actuating tool. For this purpose, tool bits have a drive portion that can be non-rotatably connected to the chuck of the actuating tool and via which the tool bit can be set into a rotary movement oriented around the longitudinal axis of the tool bit by means of motorized drive force or manual actuation by a person, as well as an output portion with a screw engagement profile on the front face, which can also be non-rotatably connected to the head of a screw to be tightened or loosened. In this manner, a variety of screws with different screw head drive profiles (e.g. slotted, Torx, hexagon socket, external hexagon, etc . . . ) and screw head sizes can be operated with a single actuating tool.

In practice, however, most users only need tool bits for a limited number of screw head drive profiles. Users of such screwdriving tools therefore very often put together the right selection of tool bits for them in an individual range, which can be stored in a container and easily carried to the place of use. Carrying such a range of tool bits has also proven its worth for users of mechanical objects, such as bicycles, so that the required tool bit is always to hand for any repairs.

For storing a plurality of tool bits, DE 20 2006 002 802 U1 discloses a multifunction tool with an adapter, the first end of which serves to hold and lock the tool in a drive unit in a non-rotatable manner and the second end of which serves to hold and lock a sleeve in a non-rotatable manner, in which in turn two further tool bits are held, wherein a first of these two tool bits is stored in the interior of the sleeve and the second tool bit is held in a position suitable for insertion into a screw head drive profile and partially protruding from the sleeve. However, such a tool consists of many individual parts and is complicated to handle, as many steps are required to change a tool bit. Especially under “outdoor” conditions in the great outdoors (i.e. outside a workshop), this causes major problems, particularly as these individual parts can easily get lost. In addition, all torques must be transferred from the drive to the output via the sleeve, which requires a correspondingly massive dimensioning of the sleeve. As a result, such a tool is not only difficult to handle, but also very bulky and cumbersome.

In a similar manner, US 2005/0105983 A1 discloses a multifunctional tool comprising a drill bit and a screw bit. The sleeve in the aforementioned DE 20 2006 002 802 U1 is replaced here by a driver that is inseparably connected to both the drill bit and the screw bit. With this solution, all torques must also be transferred from the drive to the output (in this case: drill) via the driver. This device is bulky, unwieldy and limited to a rigid connection and fixed combination of two tools.

Double-sided tool bits with different screw engagement profiles on the two front face output portions of the bit are also known from the prior art (e.g. from DE 10 2007 041 574 A1). In this manner, a combination tool is available for two different screw head drive profiles, but again only with a fixed combination of two screw engagement profiles. In view of the very large variety of different types and sizes of screw head drive profiles, there is a high probability that a user will only need one of the two screw engagement profiles of such a double-sided tool bit for his usual application needs and thus carrying such a double-sided tool bit will cause unnecessary ballast for the user. This is a considerable disadvantage, especially for cyclists who attach great importance to minimizing the pack size and weight of their equipment.

The object of the present invention is thus to provide a tool system comprising a first tool bit and a second tool bit, both tool bits each having a first end with a shank portion for transmitting a drive force to the tool bit and a second end with an output for force-transmitting insertion of the tool bit into a screw head drive profile, which overcomes the aforementioned problems. In particular, the space required for storing tool bits should be minimized without compromising usability. The aim is to ensure that a user has all the necessary tool bits at their disposal with minimum weight and space requirements. At the same time, it should be easier to use and, in particular, allow the tool bits to be changed freely.

This object is achieved in that the front face of the shank portion of each tool bit is designed as a front-face coupling region for coupling the tool bit to a second tool bit of the tool system by means of first and second coupling means integrated in the front face, the first coupling means of both tool bits being designed for the relative rotational alignment of both tool bits with respect to the central longitudinal axis of at least one tool bit, and the second coupling means being designed for transmitting a tensile force directed parallel to this central longitudinal axis to the respective other tool bit, and wherein the shank portions of both tool bits have mutually congruent outer contours and, in a coupling position of both tool bits, in which the two first coupling means of both tool bits are in direct mutual engagement with one another, form a common receiving portion for inserting the tool system into a chuck of a drive tool.

In the context of this inventive idea, “congruent outer contours” are to be understood as those outer contours of the shank portions of the tool bits which correspond with respect to their dimensions and their shape.

In the coupling position, the front-face coupling region of the first tool bit is therefore mechanically locked to the front coupling region of the second tool bit. Such a latch can be released again by the user of the tool bit. When the coupling position is brought about, the second coupling means effect a mechanical coupling of both tool bits in a linear direction of movement parallel to the central longitudinal axis or axis of rotation of both tool bits and the first coupling means effect a mechanical alignment of both tool bits in a rotational direction of movement oriented around the central longitudinal axis of the tool bits as a pole of rotation. The first coupling means (more precisely: their surfaces oriented perpendicular to the direction of rotation) act as drivers for the other tool bit when a rotary movement acts on one of the two tool bits. All tool bits intended for use in such a tool system according to the invention each have identical coupling regions on the front faces designed according to the invention. In this manner, they can be freely coupled together in any combination to form a tool system according to the invention. Both bits can be coupled directly to one another, i.e. in the coupled position they are in direct contact with one another at the front. As the first and second coupling means are a direct component of each tool bit of the tool system, no additional components, such as sleeves or drivers, are required to couple two tool bits. This reduces the dimensions and weight of a tool formed from two tool bits according to the invention. As all tool bits of the tool system have identical coupling means, it is possible to freely combine two tool bits of the tool system and thus to configure tools with freely selectable screw engagement profiles on both output sides of the tool. In this manner, a user can easily realize a tool system consisting of one or more combinations of two tool bits in coupling position to one another, the screw engagement profiles of which correspond exactly to the user's usage requirements, whereby the number of tool bits to be stored for later use is significantly reduced. This is achieved by the coupling of the tool bits according to the invention, which can be latched or separated with little manual effort by means of the aforementioned first and second coupling means.

Furthermore, a tool system in the form of a two-sided tool bit is realized in this manner according to the invention, which—in contrast to the prior art—is formed from two individual tool bits which can be coupled to one another by direct and reciprocal latching of their end coupling regions in such a manner that their shank portions form a common receiving portion in the coupled position for insertion into a drive tool. Such an embodiment of the tool bits according to the invention enables a shortening of their longitudinal extension and thus also a shortening of a tool consisting of two tool bits according to the invention coupled to one another.

The tool system according to the invention thus enables a more flexible use of the tool, while at the same time minimizing the weight and dimensions of the tool, and is geared in particular to the needs of ambitious cyclists. As both tool bits are clamped in the drive tool at the same time in the coupling position via their front-face coupled shank portions, the full torque of the drive does not have to be transmitted in the direction of the output via these front-face coupling regions. This enables the shank portions to be shortened and the front coupling regions of the tool bits arranged there to be miniaturized. Such a tool system according to the invention not only has improved usage properties, but also contributes to reducing the consumption of resources in the manufacture of tool systems, as it enables a consistent restriction to the tool bits actually required by the user.

According to a first embodiment of the inventive basic concept, the second coupling means of at least one tool bit is designed as a magnetic coupling means. This represents a particularly simple way of realizing the basic inventive idea.

According to an alternative second embodiment, the second coupling means is designed as a mechanical coupling means which effects a form fit of the second coupling means of both tool bits. This enables the transmission of higher tensile forces between the two tool bits of a tool system according to the invention.

This can be achieved, for example, by the second coupling means of both tool bits being designed as bores that are aligned with one another in the coupling position and that can be coupled to one another in a rotationally and tension-resistant manner in the coupling position by means of a split pin that can be inserted into the bores. For this purpose, the bores are preferably oriented perpendicular to the central longitudinal axis of each tool bit.

In a particularly preferred manner in this context, however, the second coupling means of both tool bits are each designed as at least one hook protruding from the front-face coupling region of a tool bit and forming an undercut, each hook of the first tool bit being designed as engaging positively in the undercut of the respective second tool bit in the coupling position. The hooks of both tool bits therefore engage alternately in the undercuts of the other tool bit. The dimensions of the hooks and undercuts are such that the engagement of each hook in the respective undercut is backlash-free, i.e. the geometric dimensions of the hooks and undercuts correspond to one another.

The basic concept according to the invention further provides that the first coupling means of at least one tool bit is designed as at least one driver protruding from the front-face coupling region of a tool bit, wherein each driver of the first tool bit is designed to engage positively in a recess of the respective second tool bit in the coupling position. Each driver protrudes from the front face of the tool bit in a direction parallel to the central longitudinal axis and preferably has at least one surface which is oriented perpendicular to the direction of rotation of a rotational movement oriented around the central longitudinal axis of the tool bit and acts as a driver of the other tool bit in the event of a rotational movement acting on one of the two tool bits.

For this purpose, the invention preferably provides that the at least one driver forms an arcuate segment of the end coupling region of the tool bit. This arc segment protrudes from the front face of the tool bit in a direction parallel to the central longitudinal axis. In a particularly preferred manner, these are circular arc segments, each of which comprises a partial segment of the front face of the coupling region. If the coupling region of a tool bit comprises a plurality of such segments, then these segments are distributed around the circumference of the front face of the coupling region, forming identical intermediate distances from one another.

The present invention is explained in more detail below with reference to three embodiments and associated drawings. In the drawings:

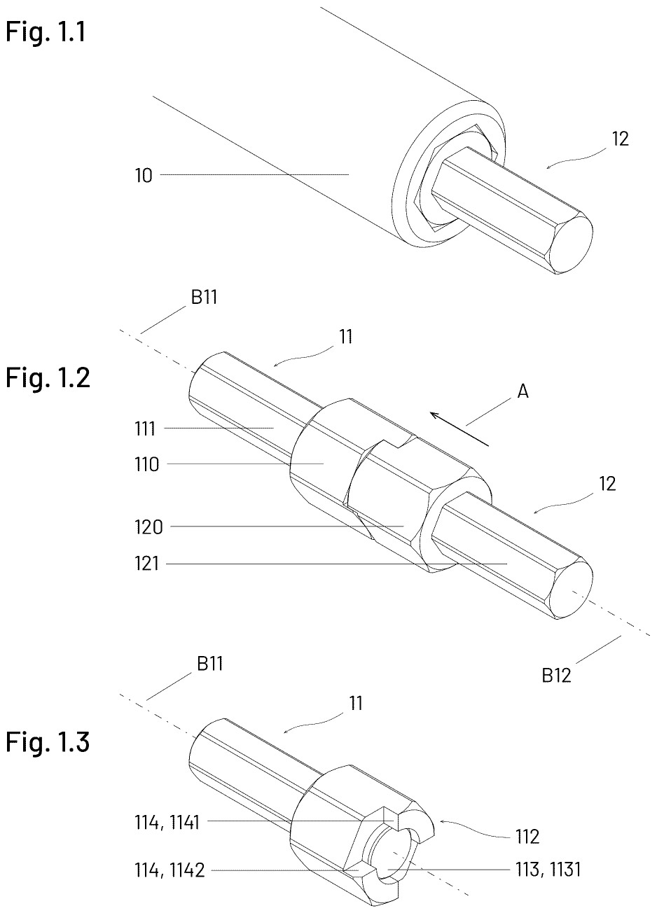

FIG. 1.1-1.3 are first embodiments of the tool system according to the invention

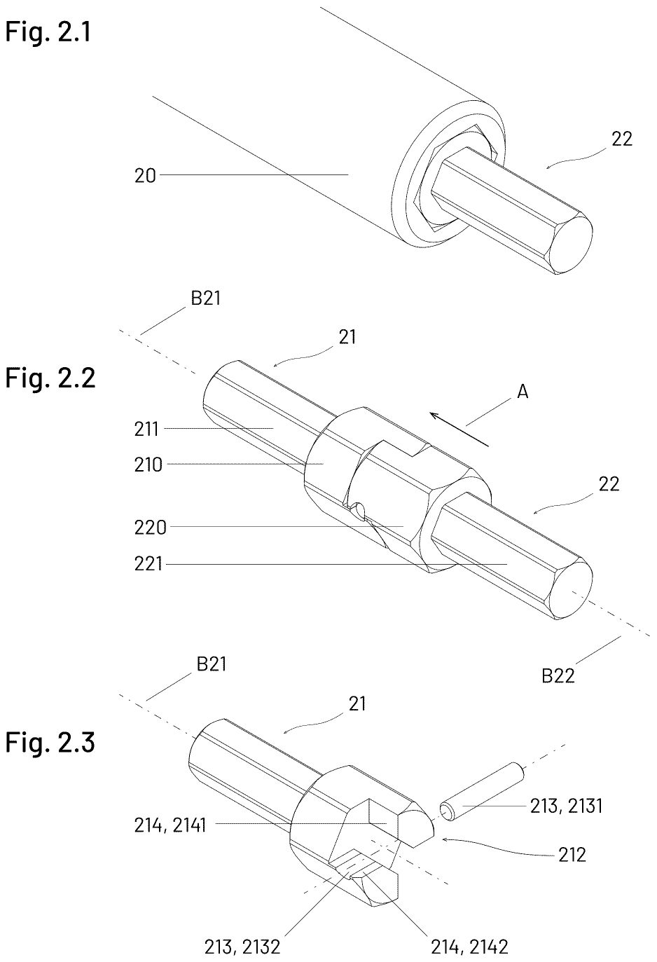

FIG. 2.1-2.3 are second embodiments of the tool system according to the invention

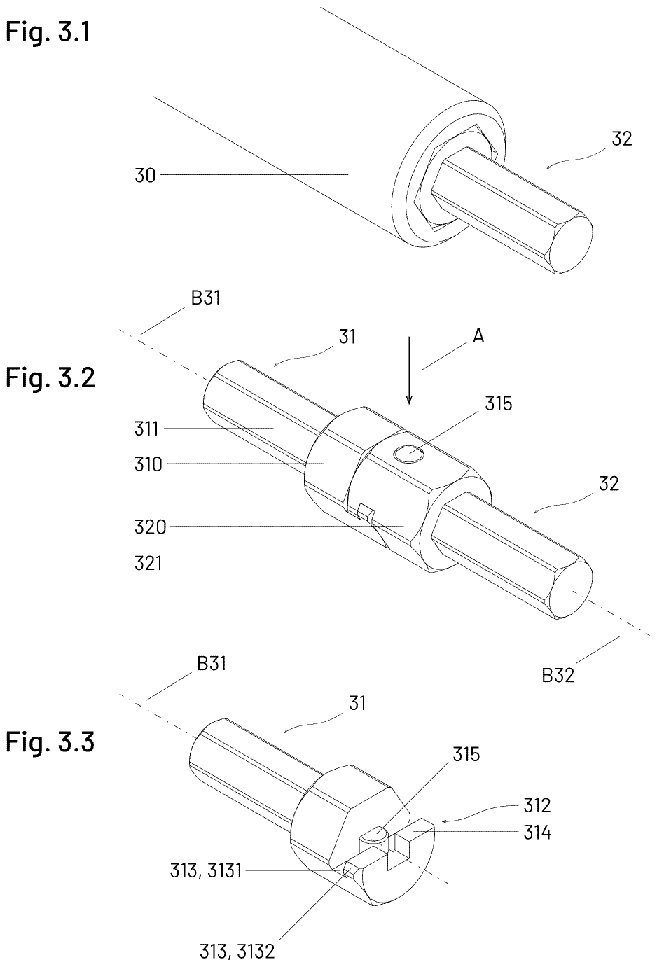

FIG. 3.1-3.3 are third embodiments of the tool system according to the invention

Each tool system according to the invention comprises a first tool bit (11, 21, 31) and a second tool bit (12, 22, 32), wherein both tool bits each have a shank portion (110, 120, 210, 220, 310, 320) for transmitting a drive force to the tool bit and an output (111, 121, 211, 221, 311, 321) for force-transmitting insertion of the tool bit into a screw head profile. The respective drive tools are only indicated in the figures by showing their chucks (10, 20, 30), in which the shank portions (110, 120, 210, 220, 310, 320) of the tool bits are inserted and fastened. In the context of this embodiment example, the two outputs of each tool system according to the invention are only shown by way of example as hexagon socket (or “Allen”) profiles of different sizes; here, many variants are possible according to the various screw head drive profiles known from the prior art. The free combinability of tool bits with a wide variety of outputs is precisely the positive effect achieved by the invention compared to the prior art.

The shank portions (110, 120, 210, 220, 310, 320) of both tool bits each have an end coupling region (112, 212, 312) on their respective front faces. The embodiments of the tool system according to the invention shown in the context of this embodiment example differ from one another in the design of this front-face coupling area, whereby all tool bits (11 and 12, 21 and 22, 31 and 32) belonging to the same embodiment have a matching design of their front-face coupling regions. According to the basic idea of the invention, all tool bits (11 and 12, 21 and 22, 31 and 32) designed according to the same embodiment can be connected to one another in a coupling position at their front face coupling regions in such a manner that both torsional and tensile forces can be transmitted between the two tool bits via the coupling regions. For this purpose, the front face coupling regions of both tool bits each have first coupling means (for the rotational alignment of both tool bits to each other) and second coupling means (for the transmission of tensile forces). The embodiments of the tool system according to the invention shown in the context of this embodiment example therefore differ from one another in the specific design of these first and second coupling means. All tool bits designed according to the same embodiment can be freely combined with one another.

In order to achieve the coupling, both tool bits (11, 12, 21, 22, 31, 32) are oriented in such a manner that their front face coupling areas are opposite one another and their central longitudinal axes (B11, B12, B21, B22, B31, B32) are aligned linearly to one another. The central longitudinal axes of the tool bits coincide with their axes of rotation. Furthermore, to bring about the coupling of the two tool bits, the coupling region of the second tool bit (12, 22, 32) is approached along a coupling direction (A) oriented parallel to the central longitudinal axis (according to the first or second embodiment (B11, B21)) or perpendicular to the central longitudinal axis (according to the third embodiment (B31)) to the coupling region of the first tool bit (11, 21, 31) up to the first contact between the two coupling regions. By means of respective first coupling means, both tool bits (11, 12, 21, 22, 31, 32) can then be rotated and aligned relative to one another about their respective central longitudinal axes (B11, B12, B21, B22, B31, B32) in such a manner that the first coupling means of both tool bits do not block one another when approaching further in the coupling direction. In addition, the contours and dimensions of the first coupling means are identical for both tool bits (11, 12, 21, 22, 31, 32). To ensure backlash-free transmission of rotary movements or even torques about the central longitudinal or rotational axes (B11, B12, B21, B22, B31, B32) of both tool bits (11, 12, 21, 22, 31, 32), these are designed in such a manner, that the contours and dimensions of the spaces between the first coupling means (114, 214, 314) of the first tool bit (11, 21, 31) correspond to the contours and dimensions of the first coupling means of the second tool bit (12, 22, 32) (and vice versa). In the coupling position, the first and second coupling means of both tool bits are in mutual engagement and the coupling regions of both tool bits are thus mechanically locked against one another. In the coupling position, both torsional and tensile forces can be transmitted between the two tool bits via the coupling regions or their first and second coupling means (114, 214, 314; 113, 213, 313).

According to a first embodiment shown in FIG. 1.1 to 1.3, the second coupling means (113) of each tool bit are designed as an internal magnet (1131) arranged concentrically to the central longitudinal axis (B11) of the tool bit (11) and the first coupling means (114) are designed as two circular arc segments (1141, 1142) which embrace this magnet (1131) and protrude from the respective end region of the shank portions and each have an arc length of 90°. The arc length of the two likewise arc-shaped intermediate spaces between these two circular arc segments (1141, 1142) corresponds to the arc length of the two circular arc segments (1141, 1142), so that no play occurs during a rotary movement about the rotational or central longitudinal axes (B11, B12) of both tool bits (11, 12) in the coupling position. Both tool bits (11, 12) have identically designed front-face coupling regions, i.e. identically designed first and second coupling means. The coupling direction (A) is parallel to the central longitudinal axes (B11, B12) of both tool bits.

FIG. 2.1 to 2.3 show a second embodiment. Analogous to the first embodiment, the first coupling means (214) are designed as two circular arc segments (2141, 2142), the dimensioning of which in the direction parallel to the central longitudinal axis (B21) of the tool bit (21) is, however, greater than in the first embodiment (i.e. the two circular arc segments (2141, 2142) have a greater dimensioning in the direction of the central longitudinal axis). In this manner, the installation space for a sufficiently large dimensioned split pin (2131) is ensured on the one hand, but on the other hand a larger surface for the transmission of rotational movements between the two tool bits is also achieved. The second coupling means are designed as aligned bores that are perpendicular to the central longitudinal axis of the tool bit and can be coupled to one another in the coupling position by means of a split pin (2131) that can be inserted into the bores in a rotationally and tension-resistant manner. The split pin (2131) can be magnetized to prevent it from falling out of the bore (2132). Preferably, the magnetization of the split pin (2131) is diametrical, i.e. the magnetic axis, at the ends of which the magnetic poles are located, runs through the diameter of the split pin. In this manner, the split pin (2131) can be pressed out to release the coupling position with only a small amount of force, which significantly improves the operability and the usage properties of the tool system according to the invention. The bores (2132) are positioned on each tool bit in the circumferential direction in such a manner that they only penetrate half of the first coupling means or circular arc segments (2141, 2142) of both tool bits that are in contact with one another in the coupling position. In this manner, an identical geometric design of the coupling regions of both tool bits is ensured. The coupling direction (A) is parallel to the central longitudinal axes (B21, B22) of both tool bits.

FIG. 3.1 to 3.3 show a third embodiment in which the second coupling means is designed as a hook (3132) protruding from the front-face coupling region of the tool bit and forming an undercut (3131). The contour and dimensions of the hook (3132) and undercut (3131) correspond to one another in such a manner that each hook of a first tool bit engages positively and without play in the undercut of the respective second tool bit in the coupling position. In addition, a diametrically magnetized magnet (315) projecting into the undercut (3131) is provided which, in the coupling position of both tool bits, interacts with the magnet of the respective other tool bit, which is identical to it, and in this manner prevents the hook of the respective other tool bit from being released from the undercut (3131). The first coupling means (314) is designed as a semicircular arc segment. In contrast to the first and second embodiments shown above, in this third embodiment the coupling direction (A) is not parallel to the central longitudinal axes (B31, B32) of both tool bits, but is oriented perpendicular to them, so that when both tool bits approach one another, the hook of the first tool bit penetrates into the undercut of the second tool bit (and vice versa).

### LIST OF REFERENCE NUMBERS

10,20, 30 chuck
11,21, 31 first tool bit
12, 22, 32 second tool bit
110, 210, 310 receiving portion of the first tool bit
120, 220, 320 receiving portion of the second tool bit
111, 211, 311 output of the first tool bit
121, 221, 321 output of the second tool bit
112, 212, 312 front-face coupling region of the first tool bit
113, 213, 313 second coupling means of the first tool bit
1131 magnet
2131 split pin
2132 half bore
undercut
3132 hooks
114, 214, 314 first coupling means of the first tool bit
1141, 1142 circular arc segment (first embodiment)
2141, 2142 circular arc segment (second embodiment)
315 magnet
A coupling direction
B11, B21, B31 central longitudinal axis of the first tool bit
B12, B22, B32 central longitudinal axis of the second tool bit

1. A tool system comprising:
a first tool bit; and
a second tool bit,
wherein each of the first tool bit and the second tool bit has a first end with a shank portion for transmitting a drive force to the tool bit and a second end with an output for force-transmitting insertion of the tool bit into a screw head drive profile,
wherein the front face of the shank portion of each tool bit is designed as an front-face coupling region for coupling the tool bit to a second tool bit of the tool system by first and second coupling means integrated in the front face respectively,
wherein the first coupling means of both tool bits are designed for the relative rotational alignment of both tool bits with respect to the central longitudinal axis of at least one tool bit,
wherein the second coupling means are arranged to transmit a tensile force directed parallel to this central longitudinal axis to the respective other tool bit, and
wherein the shank portions of both tool bits have mutually congruent outer contours and, in a coupling position of both tool bits, in which the first two coupling means of the two tool bits are in direct mutual engagement with one another, form a common receiving portion for introducing the tool system into a chuck of a drive tool.

2. The tool system according to claim 1, wherein the second coupling means of at least one tool bit is designed as a magnetic coupling means.

3. The tool system according to claim 1, wherein the second coupling means is designed as a mechanical coupling means effecting a form fit of the second coupling means of both tool bits.

4. The tool system according to claim 3, wherein the second coupling means of both tool bits are designed as bores which are aligned with one another in the coupling position and are coupled to one another in a rotationally and tension-resistant manner in the coupling position by a split pin inserted into the bores.

5. The tool system according to claim 3, wherein the second coupling means of both tool bits are each designed as at least one hook projecting from the front-face coupling region of a tool bit and forming an undercut, each hook of the first tool bit being designed as engaging positively in the undercut of the respective second tool bit in the coupling position.

6. The tool system according to claim 1, wherein the first coupling means of at least one tool bit is designed as at least one driver projecting from the front-face coupling region of a tool bit, each driver of the first tool bit being designed as engaging positively in a recess of the respective second tool bit in the coupling position.

7. The tool system according to claim 6, wherein the at least one driver forms an arcuate segment of the front-face coupling region of the tool bit.

8. The tool system according to claim 2, wherein the first coupling means of at least one tool bit is designed as at least one driver projecting from the front-face coupling region of a tool bit, each driver of the first tool bit being designed as engaging positively in a recess of the respective second tool bit in the coupling position.

9. The tool system according to claim 3, wherein the first coupling means of at least one tool bit is designed as at least one driver projecting from the front-face coupling region of a tool bit, each driver of the first tool bit being designed as engaging positively in a recess of the respective second tool bit in the coupling position.

10. The tool system according to claim 4, wherein the first coupling means of at least one tool bit is designed as at least one driver projecting from the front-face coupling region of a tool bit, each driver of the first tool bit being designed as engaging positively in a recess of the respective second tool bit in the coupling position.

11. The tool system according to claim 5, wherein the first coupling means of at least one tool bit is designed as at least one driver projecting from the front-face coupling region of a tool bit, each driver of the first tool bit being designed as engaging positively in a recess of the respective second tool bit in the coupling position.
